(19) United States
(12) Patent Application Publication
(10) Pub. No.: US 2006/0105130 A1
(43) Pub. Date: May 18, 2006

(54) Articles incorporating sulfoisophthalic acid-modified polyester multilayer coextruded structures

(76) Inventor: Michael Joseph Brown, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/273,172

(22) Filed: Nov. 14, 2005

Related U.S. Application Data
(60) Provisional application No. 60/627,223, filed on Nov. 12, 2004.

(51) Int. Cl. B32B 27/08

(52) U.S. Cl. 428/35.7

(57) ABSTRACT

Multilayer structures for thermoformed articles comprise, or are produced from, a layer comprising a sulfobenzenedicarboxylic acid-containing polyester; an optional layer comprising polyamide or a blend of at least two polyamides; an optional layer comprising polyester; an optional layer comprising polycarbonate; and an optional layer comprising foil, paper, paperboard and nonwoven fibrous material.

This application claims priority to U.S. provisional application 60/627,223, filed Nov. 12, 2004, the entire disclosure of which is incorporated herein by reference.

This invention relates to polyester-containing multilayer coextruded structures and articles therefrom and to a multilayer structure comprises a polyester composition comprising a sulfobenzenedicarboxylic acid comonomer or a salt thereof.

### BACKGROUND OF INVENTION

Thermoplastic materials are commonly used to manufacture various shaped articles which may be utilized in applications such as automotive parts, food containers, signs, packaging materials and the like. The use of polyethylene terephthalate (PET) and similar materials as the materials of choice in the formation of numerous thermoformed articles is well known in the art. Among the reasons for this is the fact that PET and similar materials offer a wide range of desirable properties. Specifically, PET materials generally have high strength, high gloss, good clarity, and low gas permeation characteristics. Further, PET materials are comparatively easy to recycle. Accordingly, they are desirable for use in packaging applications.

However, for some applications, containers made from PET may not provide adequate barriers to, for example, gas and/or moisture permeation into or out of the container. Other needs may include protection of the contents from degradation by visible and/or ultraviolet light.

Blends of polyester with other polymers may be used to provide improved barrier properties, but they have the disadvantage that they are not suitable for conventional polymer recycling streams.

Alternatively, multilayer structures, in which various performance materials are placed in interior layers surrounded by polyester exterior layers, have been developed to address the needs for improved barrier materials. Other desirable properties in a multilayer package include improved heat distortion and sealing characteristics, improved flexibility in creating colored packages and the like. Furthermore, multilayer structures must be able to retain interlayer adhesion during various processes used to prepare packaging materials, such as thermoforming, heat sealing, and the like.

Multilayer structures are often made with polymers having differing compositions that are incompatible with one another. Consequently, the multilayer structures may exhibit poor adhesion between the various layers, resulting in a poor packaging material. Many compositions under consideration for performance layers in multilayer packaging are either incompatible with polyesters such as PET, and/or they are sufficiently different so they cannot be introduced into conventional polymer recycling streams without separation. In many cases the lack of compatibility will result in unacceptably increased haze when regrind is used. Regrind is a composition comprising all the components of a multilayer structure, which typically results from recycling ground trim or scrap from operations related to forming articles from the multilayer structure. Regrind may be blended back into virgin resins and/or used as a discrete (bulking) layer in a multilayer structure.

Multilayer structures comprising PET and various performance layers providing improved barrier properties are known. For example, Japanese Patent Application 04-051423 and Japanese Patent 2663578 disclose multilayer containers comprising a polyamide barrier layer adhered to a polyester layer with a sulfonic-acid containing copolyester adhesive layer.

Patent Cooperation Treaty Patent Application Publication WO99/58328 discloses multilayer structures displaying improved recyclability in which a hydrolytically labile release aid is present.

However, there still remains a significant need for multilayer structures with adequate interlayer adhesion and barrier properties during use that can be readily recycled after use. There is also a significant need for barrier structures that provide good clarity, particularly when regrind is introduced. There is also a significant need for heat resistant barrier structures that exhibit improved barrier performance under retort conditions.

### SUMMARY OF THE INVENTION

The invention provides a multilayer structure comprising a first layer, a second layer, and optionally, a second layer, a third layer, a fourth layer, a fifth layer, or combinations of two or more thereof, the layer comprising or produced from a sulfobenzenedicarboxylic acid-containing polyester, a sulfobenzenedicarboxylic acid-containing polycarbonate. The sulfobenzenedicarboxylic acid-containing polyester comprises from 0.01 to 7 mole % of a sulfobenzenedicarboxylic acid comonomer or a salt thereof, a random copolyester, a block copolyester, or a blend of bulk polyester and a copolymer of polyester and a sulfobenzenedicarboxylic acid comonomer or a salt thereof. The sulfobenzenedicarboxylic acid comonomer is a salt of alkali metal ion, alkaline earth metal ion, transition metal ion, or combinations of two or more thereof; the ion is preferably calcium, zinc, lithium and sodium; and is further preferably sodium. The optional second layer comprises or is produced from polyamide, a blend of at least two polyamides, a blend of at least one partially aromatic and at least one aliphatic polyamide, a blend of at least two partially aromatic polyamides, a blend of polyamide 6I,6T and polyamide 6,6, a blend of polyamide 6I,6T and polyamide MXD6, at least one partially aromatic and at least one aliphatic polyamide, or at least two partially aromatic polyamides. The optional third layer comprises or is produced from polyester. The optional fourth layer comprises or is produced from polycarbonate. The optional fifth layer comprises or is produced from foil, paper, paperboard, nonwoven fibrous material, or combinations of two or more thereof. The term “first, second, third, fourth, or fifth” does not mean the layers are such order, but merely for easy reference and distinction.

### DETAILED DESCRIPTION OF THE INVENTION

The term “containers” used herein means shaped articles for use in packaging or containing foods, medicines, agrochemicals, industrial liquids and the like, and the “containers” include, for example, boxes, blister packs, bottles, trays, cups, and other like-bottomed containers.

The term “polymer” refers to the product of a polymerization reaction, and is inclusive of homopolymers, copolymers, terpolymers, tetrapolymers, etc. In general, a layer within a multilayer structure can consist essentially of a single polymer, or a layer can comprise two or more different polymers blended together.

The term “copolymer” refers to polymers formed by the polymerization of at least two different monomers. The term “copolymer” is also inclusive of random copolymers, block copolymers, and graft copolymers.

The term “polymerization” is inclusive of homopolymerizations, copolymerizations, terpolymerizations, etc., and includes all types of copolymerizations such as random, graft, block, condensation, etc. The polymers, in the structures disclosed herein, can be prepared in accordance with any suitable polymerization process, including slurry polymerization, gas phase polymerization, and high pressure polymerization processes.

As used herein, terms identifying polymers, such as “polyamide”, “polyester”, “polycarbonate”, etc. are inclusive of not only polymers comprising repeat units derived from monomers known to polymerize to form a polymer of the named type, but are also inclusive of comonomers, derivatives, etc. that can copolymerize with monomers known to polymerize to produce the named polymer. For example, the term “polyamide” encompasses both polymers comprising repeating units derived from monomers, such as caprolactam, which polymerize to form a polyamide, and copolymers derived from the copolymerization of caprolactam with a comonomer which when polymerized alone does not result in the formation of a polyamide. Furthermore, terms identifying polymers are also inclusive of blends of such polymers with other polymers of a different type.

Typical polyamide resins include aliphatic polyamides such as polyamide 6, polyamide 9, polyamide 10, polyamide 11, polyamide 12, polyamide 6,6, polyamide 6,6/6, polyamide 6,9, polyamide 6,10, and polyamide 6,12 and polyamides prepared from 2,2-bis-(p-amino-cyclohexyl)propane; and aromatic or partially aromatic polyamides such as polyamide 61, polyamide 6T, polyamide 6I,6T, polyamides prepared from terephthalic acid and/or isophthalic acid and trimethylhexamethylene-diamine as well as those prepared from adipic acid, azelaic acid, from terephthalic acid and 4,4′-diaminocyclohexylmethane, and polyamide MXD6 (comprising m-xylylenediamine and adipic moieties); and copolymers thereof.

Mixtures and/or copolymers of two or more of the foregoing polyamides or prepolymers thereof, respectively, are also within the scope disclosed herein.

Polyamides may be made by any known method, including the polymerization of a monoamino monocarboxylic acid or a lactam thereof having at least two carbon atoms between the amino group and carboxylic acid group, of substantially equimolar proportions of a diamine which contains at least two carbon atoms between the amino groups and a dicarboxylic acid, or of a monoaminocarboxylic acid or a lactam thereof as define above, together with substantially equimolar portions of a diamine and a dicarboxylic acid. This dicarboxylic acid may be used in the form of a functional derivative thereof, for example, a salt, an ester or acid chloride.

Polyamides and polyamide precursors are disclosed in U.S. Pat. No. 4,755,566 and other useful polyamides often referred to as “nylons” are disclosed in U.S. Pat. Nos. 4,732,938; 4,659,760; and 4,315,086. The polyamide used may also be one or more of those referred to as “toughened nylons,” which are often prepared by blending one or more polyamides with one or more polymeric or copolymeric elastomeric toughening agents. Examples of these types of materials are given in U.S. Pat. Nos. 4,174,358; 4,474,927; 4,346,194; 4,251,644; 3,884,882; and 4,147,740.

The polyamide in the polyamide layer preferably comprises at least one polyamide selected from the group consisting of polyamide 6, polyamide 6,6/6, polyamide 10, polyamide 11, polyamide 12, polyamide 6,6, polyamide 6,9, polyamide 6,10, polyamide 6,12, polyamide 6I, polyamide 6T, polyamide 6I,6T, polyamide MXD6, and copolymers thereof. Preferably, the polyamide layer comprises polyamide 6, polyamide 6,6, polyamide 6I,6T, or combinations of two or more thereof. Preferred polyamide layers also include polyamide nano-composites such as those available commercially under the tradename Aegis™ from Honeywell or Imperm™ from Mitsubishi Gas Chemicals/Nanocor.

Of note are polyamide compositions comprising blends of at least two polyamides. Also of note are polyamide compositions comprising blends of at least one partially aromatic polyamide and at least one aliphatic polyamide. Also of note are polyamide compositions comprising blends of at least two partially aromatic polyamides. Further of note are blends of polyamide 6I, 6T and polyamide 6,6; blends of polyamide 6I,6T and polyamide 6; and blends of polyamide 6I,6T and polyamide MXD6. Also of note are multilayer structures and articles, as described herein, comprising these blends.

For example, multilayer structures include the multilayer structure comprising (1) a layer comprising a blend of at least two polyamides; (2) a layer comprising a blend of at least one partially aromatic and at least one aliphatic polyamide; (3) a layer comprising a blend of at least two partially aromatic polyamides; (4) a layer comprising a blend of polyamide 6I,6T and polyamide 6,6; or (5) a layer comprising a blend of polyamide 6I,6T and polyamide MXD6.

In condensation polymers such as polyesters, comonomers combine by, for example, esterification or transesterification reactions with the elimination of water or low-molecular weight alcohols. Polyesters comprise repeat units derived from at least one diol comonomer and at least one dicarboxylic acid comonomer.

“Polyester” as used herein includes, for example, polyethylene terephthalate (PET), polypropylene terephthalate, polybutylene terephthalate (PBT), and blends with additional components such as modifiers and tougheners (for example PBT and/or PET blends). Preferred for use in the present invention is a polyester composition comprising at least about 65 weight % PET, or at least about 80 weight % PET. The PET can be a homopolymer or copolymer of PET. The term “PET homopolymer” means a polymer substantially derived from the polymerization of ethylene glycol with terephthalic acid, or alternatively, derived from the ester forming equivalents thereof (e.g., any reactants that can be polymerized to ultimately provide a polymer of PET). The term “copolymer of PET” means any polymer comprising (or derived from) at least about 50 mole percent ethylene terephthalate, and the remainder of the polymer being derived from monomers other than terephthalic acid and ethylene glycol (or their ester-forming equivalents). Other comonomers include, for example, di-acids such as succinic acid, adipic acid, azelaic acid, sebacic acid, glutaric acid 1,10-decanedicarboxylic acid, phthalic acid, isophthalic acid, dodecanedioic acid, and the like; and ester-forming equivalents thereof. Ester-forming equivalents of note are diesters such as, for example, dimethylphthalate. Other comonomers include, for example, diols such as propylene glycol, propanediol, methoxypolyalkylene glycol, neopentyl glycol, trimethylene glycol, tetramethylene glycol, hexamethylene glycol, diethylene glycol, polyethylene glycol, cyclohexane dimethanol and the like. Trimellitic anhydride, trimellitic acid, pyromellitic dianhydride (PMDA), penterithritol or other acids or diols that have more than two reactive sites can be incorporated as branching agents to increase the melt viscosity and improve the rheology for coextrusion for multilayer thermoformable sheets or melt-formable articles.

As indicated above, polyesters can also be blended with other components such as tougheners. Tougheners include, for example but not limitation, ethylene copolymers such as ethylene/alkyl (meth)acrylate copolymers (e.g. ethylene/methyl acrylate), ethylene/alkyl acrylate/glycidyl (meth)acrylate copolymers (e.g. ethylene/n-butyl acrylate/glycidyl methacrylate—EnBAGMA) and ethylene/(meth)acrylic acid copolymers, at least partially neutralized with metal ions (ionomers). Toughened polyesters typically comprise from about 3 to about 20 weight % of tougheners, alternatively from about 8 to about 20 weight %, preferably from about 8 to about 15 weight %.

Polyesters may also be nucleated to improve crystallinity and optical clarity. Suitable nucleation agents include salts of organic acids, such as sodium stearate. Polyesters may also contain inorganic fillers such as glass fibers, talc, and/or other mineral reinforcements to increase the stiffness and heat resistance of the composition, especially for crystalline polyethylene terephthalate (CPET). Accordingly, this invention provides multilayer structures and articles therefrom wherein the multilayer structure comprises at least one additive selected from the group consisting of tougheners, nucleation agents and inorganic fillers.

The polyester composition can be a blend of a polyester copolymer comprising from 0.01 and 7 mole % of a sulfobenzenedicarboxylic acid comonomer or a salt thereof with a PET homopolymer or copolymer having a melt temperature (Tₘ) in a range from about 230° C. to 258° C. and an inherent viscosity (IV) from 0.58 to 1.1. Polyesters such as this are sometimes referred to as “bottle resins” and include those such as “9921” from Voridian or “Laser+®” from DAK Americas. These resins typically provide amorphous PET. CPET resins include those such as Crystar® 5005 from E. I. du Pont de Nemours and Company (DuPont). Of note is a bulk polyester comprising a PET homopolymer or copolymer with Tₘ in a range from about 245° C. to 258° C. and an IV from 0.67 and 1.1. Preferred is a PET homopolymer or copolymer with Tₘ in a range from about 245° C. to 258° C. and an IV from 0.75 and 0.95.

The copolymer of polyester and a sulfobenzenedicarboxylic acid used herein includes any polymer comprising (or derived from) terephthalic acid or a terephthalate diester such as dimethylterephthalate and ethylene glycol in amounts such that the copolymer comprises at least about 50 mole percent ethylene terephthalate, and the remainder of the polymer being derived from monomers comprising a sulfo (i.e. sulfonic acid) moiety, such as sulfoterephthalic acid or 5-sulfoisophthalic acid, their salts and/or ester forming equivalents thereof.

Sulfobenzenedicarboxylic acid can have the formula of (RO(O)C)₂ArS(O)₂OM in which each R can be the same or different and is hydrogen or an alkyl group containing 1 to about 6 carbon atoms. Ar is a phenylene group. M can be an alkali metal ion. An example is 5-sulfoisophthalic acid (5-SIPA); an example of an ester forming equivalent thereof is the sodium salt of 5-sulfo-1,3-dimethyl ester 1,3-benzenedicarboxylic acid (also known as 5-sodium sulfodimethylisophthalate; CAS Registry Number 3965-55-7).

Typically, the copolymer is in the neutralized form (i.e. in the form of an alkali metal, alkaline earth metal or transition metal salt). When in the salt form, these copolymers are also known as polyester ionomers, sulfonate polyesters or metal sulfonate polyesters. The term “sulfonic acid-containing polyester copolymer” denotes such copolymers, including the salt form. Suitable polyester ionomers are described in U.S. Pat. No. 6,437,054. Preferred is a polyester copolymer derived from copolymerization of ethylene glycol with terephthalic acid and 5-sulfoiso-phthalic acid (or equivalents, including esters and/or salts).

The copolymers of polyester or polycarbonate and a sulfobenzenedicarboxylic acid include random copolymers or block copolymers. Random copolymers are copolymers in which all the comonomers of the copolymer are mixed together simultaneously and condensed. This results in a random distribution of the sulfobenzenedicarboxylic moiety through the copolymer. For example, a block polyester copolymer is prepared by mixing the terephthalic acid comonomer and the ethylene glycol comonomer and allowing them to partially condense prior to adding the sulfobenzenedicarboxylic comonomer. The resulting block copolymer has “blocks” or regions of essentially homogeneous PET and regions wherein the sulfobenzene-dicarboxylic moieties are randomly distributed among the terephthalic and ethylene glycol moieties. Trimellitic anhydride, trimellitic acid, PMDA, penterithritol or other acids (or equivalents) or diols that have more than two reactive sites can be incorporated as branching agents to increase the melt viscosity and improve the rheology for coextrusion.

For example, a random copolymer can comprise from 0.01 to 7 mole % of a sulfobenzenedicarboxylic acid comonomer or a salt thereof. This copolymer is suitable for blending with a bulk polyester to form a composition used in this invention.

Also for example, a block copolymer can comprise from 0.01 to 7 mole % of a sulfobenzenedicarboxylic acid comonomer or a salt thereof. This copolymer is suitable for blending with a bulk polyester to form a composition used in this invention.

A PBT homopolymer is also suitable as the bulk polyester into which the sulfonic acid-containing polyester copolymer is blended. When PBT is used as the bulk polyester, the sulfonic acid-containing polyester copolymer is preferably derived from copolymerization of tetramethylene glycol (butylene glycol) with terephthalic acid and 5-sulfoisophthalic acid (or equivalents, including esters and/or salts). These copolymers can be prepared as described above by substitution of tetramethylene glycol for ethylene glycol. These copolymers can be random copolymers (in which all the comonomers of the copolymer are mixed together simultaneously and condensed) or block copolymers (prepared by mixing the terephthalic acid comonomer and the tetramethylene glycol comonomer and allowing them to partially condense prior to adding the sulfobenzenedicarboxylic comonomer).

Polycarbonates can be used as the bulk polymer into which the sulfonic acid-containing polyester copolymer is blended.

The phrases “inner layer,” “interior layer” and “internal layer” refer to any layer of a multilayer structure having both of its principal surfaces directly adhered to another layer of the structure.

The phrases “outer layer” and “exterior layer” refer to any layer of a multilayer structure having less than two of its principal surfaces directly adhered to another layer of the structure. All multilayer structures have two, and only two, outer or exterior layers, each of which has a principal surface adhered to only one other layer of the multilayer structure.

The phrase “inside layer” refers to an outer or exterior layer of a multilayer structure for packaging goods that is closest to the packaged goods relative to the other layers of the multilayer structure. “Inside layer” also is used with reference to the innermost layer of a plurality of concentrically arranged layers simultaneously coextruded through an annular die.

The phrase “outside layer” refers to the outer layer of a multilayer structure that is farthest from the packaged goods relative to the other layers of the multilayer structure. “Outside layer” also is used with reference to the outermost layer of a plurality of concentrically arranged layers simultaneously coextruded through an annular die.

The phrase “directly adhered”, as applied to layers, is defined as adhesion of the subject layer to the object layer, without an intervening tie layer, adhesive layer, or other layer. In contrast, as used herein, the word “between”, as applied to a layer expressed as being between two other specified layers, includes both direct adherence of the subject layer to other two layers it is between, as well as including a lack of direct adherence to either or both of the two other layers the subject layer is between, i.e., one or more additional layers can be imposed between the subject layer and one or more of the layers the subject layer is between.

The terms “core” and “core layer”, as applied to multilayer structures, refer to any interior layer that has a primary function other than serving as an adhesive or compatibilizer for adhering two layers to one another. Usually, the core layer or layers provide the multilayer structure with a desired level of strength (i.e., modulus) and/or optics, and/or added abuse resistance, and/or specific impermeability.

The phrase “tie layer” or “adhesive layer” refers to any interior layer having the primary purpose of adhering two layers to one another. Tie layers can comprise any polymer having a polar group thereon, or any other polymer that provides sufficient interlayer adhesion to adjacent layers comprising otherwise nonadhering polymers.

Tie layer compositions include those sulfobenzenedicarboxylic acid-derived polyester compositions described above. They may also include blends of sulfobenzenedicarboxylic acid-derived copolymers with PET (preferably a PET having a high IV and/or a branched PET). The compositions may also be toughened and/or nucleated as described above (for example, inclusion of 18 weight % EnBAGMA and/or a sodium salt of an organic acid to provide 1000 ppm Na⁺). Although the compositions are generally described herein as containing sodium counterions, other counterions such as lithium, calcium and zinc may be used. Low-melting SIPA-PET copolymers may be particularly useful in some multilayer structures.

The phrase “bulk layer” refers to any layer of a structure that is present for the purpose of increasing the abuse-resistance, toughness, modulus, etc., of a multilayer structure. Bulk layers generally comprise polymers that are inexpensive relative to other polymers in the structure that provide some specific purpose unrelated to abuse-resistance, modulus, etc.

The term “barrier” and “barrier layer”, as applied to multilayer structures, refer to the ability of a structure or layer to serve as a barrier to one or more gases. In the packaging art, oxygen (i.e., gaseous O₂) barrier layers have included, for example, hydrolyzed or saponified ethylene/vinyl acetate copolymer (also referred to as “ethylene/vinyl alcohol copolymer” (EVOH)), polyalcohol ethers, polyvinylidene chloride, polyamides, polyacrylonitrile, polyesters, wholly aromatic polyesters, resorcinol diacetic acid-based copolyesters, polyalcohol amines, isophthalate-containing polyesters, polyethylene naphthoate and its copolymers, and combinations of two or more thereof, etc., as known to one skilled in the art. Topase cyclic olefin copolymer available from Ticona can be used to improve the moisture barrier. These materials may be used neat or further modified to improve their physical properties, such as with the addition of nanoparticles (to improve barrier), such as those available from Nanocor, Southern Clay Products, Rheox and others.

The phrase “skin layer” refers to an outside layer of a formed multilayer structure, this skin layer being subject to abuse.

The phrase “content-contact layer” refers to a layer of a multilayer packaging structure such as a tray that is in direct contact with the contents held in the tray. In a multilayer structure, a content-contact layer is always an outer layer. The content-contact layer is an inside layer in the sense that with respect to the package, the content-contact layer is the inside layer (i.e., the innermost layer) of the package.

As noted above, a multilayer structure of this invention may comprise at least one layer comprising a sulfobenzenedicarboxylic acid-derived polyester composition as defined above; and at least one polyamide layer. A multilayer structure of this invention may comprise at least one inner layer comprising a sulfobenzenedicarboxylic acid-derived polyester composition as defined above, at least one polyamide layer, and at least one polyester layer or at least one polycarbonate layer.

Optionally an additional barrier layer or abuse layer could be included.

The sulfobenzenedicarboxylic acid-derived polyester compositions disclosed above provide high-strength bonds between the polyamides and polyesters or polycarbonates, allowing the preparation of multilayer structures. Those bonds may be relatively unaffected by the presence of solvents, unlike conventional olefin tie layers and bond strength can be adversely affected in high humidity and high temperature environments. It may be desirable to utilize these structures for packaging refrigerated or frozen foods, such as meats, cheeses, fresh pasta and the like. Packages comprising multilayer structures as disclosed herein can be useful for modified atmosphere packaging. Because of the high-temperature performance of the sulfoisophthalic acid-containing polyester resins when used as a tie layer, some structures may be suitable for ovenable or retort applications. Accordingly, this invention provides articles that are heat stable under microwave conditions, retort conditions, and/or conventional oven or convection oven conditions.

Typically, a multilayer structure of this invention comprises at least two layers, but the present invention is not restricted in the numbers of materials and layers included in the structure. Typical structures could include up to 13 layers, more typically up to 5 to 7 layers.

A three-material, three-layer structure that can be coextruded into, for example, a thermoformable sheet can comprise a first exterior layer comprising a polyester composition, an inner layer comprising a sulfobenzenedicarboxylic acid-derived polyester composition, and a second exterior layer comprises a polyamide composition. For articles such as trays, one exterior layer provides the outside surface of the article and the other exterior layer provides the inside surface (the content-contact surface) of the article.

A three-layer structure can be a “PET/tie/polyamide” structure where “tie” indicates a sulfobenzenedicarboxylic acid-derived polyester composition as described herein and “PET” indicates a thermoplastic PET. Depending on the use, either the PET or the polyamide layer can function as the outside surface of the thermoformed article.

Another three-layer structure can be a “polycarbonate/tie/polyamide” structure where “tie” indicates a sulfobenzenedicarboxylic acid-derived polyester composition as described herein. In this example, the polycarbonate serves as the outside layer of a thermoformed article and the polyamide serves as the inside layer. The polyamide may be toughened as disclosed above. A multilayer structure comprising “polycarbonate/tie/toughened polyamide” may be useful for high temperature applications.

The invention is also useful, for example, in four-material, four-layer structures where four materials form a four-layer object, typical applications would be for a thermoformed multilayer structure comprising two interior layers; one layer can be a sulfobenzenedicarboxylic acid-derived polyester composition as disclosed above as a tie layer and the other interior layer can be selected for its barrier properties or for some other property such as a structural layer or a recycled (regrind) layer. The exterior layers can comprise a layer comprising a polyester composition and a layer comprising a polyamide as disclosed above. Examples of five-layer structures include (1) polyamide 6/tie/PET/tie/polyamide 6; (2) polyamide 6I,6T/tie/PET/tie/polyamide 6I,6T; and (3) PET/tie/polyamide 6I,6T/tie/PET where “tie” indicates a sulfobenzenedicarboxylic acid-derived polyester composition as described herein and “PET” indicates a polyethylene terephthalate as described herein.

The compositions disclosed herein can be formed into multilayer structures with other polymers, e.g. polyolefin resins such as polyethylene, polypropylene, ethylene/vinyl acetate copolymers, ethylene/(meth)acrylate copolymers, ethylene/(meth)acrylic acid copolymers and EVOH.

The multilayer polymer film or sheet can involve at least three categorical layers including, but not limited to, an outermost structural or abuse layer, an inner barrier layer, and an innermost layer making contact with and compatible with the intended contents of the package and capable of forming seals necessary for enclosing the product to be contained within the package. The seals can be formed of heat-sealable polymers. Other layers may also be present to serve as adhesive or “tie” layers to help bond these layers together.

The inner layer can include one or more barrier layers, depending on which atmospheric conditions (oxygen, humidity, ethylene, carbon dioxide) that potentially can affect the product inside the container.

Inner core layers can be a barrier layer, where a moisture-sensitive barrier layer may be required within the multilayer structure such as a container. The barrier layer may be shifted towards the outside walls of the container, away from the liquid content and thus at a lower relative humidity environment that can enhance the performance of the barrier layer and even require less volume of barrier material in order to provide the same barrier effect to the contents. Another illustration is for use of adhesive layers, the performance of which may be affected by being in a higher relative humidity and/or being closer to the core as opposed to being close to the outside wall. A thicker outside layer, moreover, would permit less moisture permeation than if the outside layer were thinner, slowing down moisture transfer from the outside to the adhesive or barrier layer. While the invention is useful with all kinds of polymers as components of the interior core layer, at least one polymer selected from the group consisting of polyamides (nylons), EVOH copolymers, polyvinylidene chloride, polyglycolic acid, and polyalkylene carbonate is useful for barrier properties. In structures for which polyamide 6I,6T is used as the barrier, the polyamide barrier layer may be located closer to the liquid.

Conventional oxygen barrier layers include polyethylene vinyl alcohol having from about 20 to about 40 mole % ethylene (EVOH). EVOH includes saponified or hydrolyzed ethylene/vinyl acetate copolymers, and refers to a vinyl alcohol copolymer having an ethylene comonomer, and prepared by, for example, hydrolysis of vinyl acetate copolymers, or by chemical reactions with polyvinyl alcohol. The degree of hydrolysis is preferably from about 50 to 100 mole %, or from about 85 to 100 mole %. Typical polyethylene vinyl alcohol polymers are commercially available under the tradename Evalca® from Kuraray Ltd. or commercially available under the tradename Soarnol® from Noltex Inc., for example.

Polyamide barrier layers include polyamide MXD6 (polymetaxylylene adipamide) and polyamide 6I,6T. Typical polymetaxylylene adipamide is available from Mitsubishi Gas Chemical Ltd. under the product name Inperm™. Typical amorphous polyamide 6I,6T is available from DuPont under the product name Selar® PA.

Another barrier composition is polyvinylidene chloride. Typical polyvinylidene chloride (PVDC) copolymer used as a barrier resin can be obtained commercially from Dow Chemical under the tradename Saran®. Other barrier layers can be, for example, PVDC homopolymer, metallized polypropylene, aluminum foil, silica, alumina, carbon, or composites of the same as well as related copolymers thereof. Barrier layer thickness may depend on the sensitivity of the product and the desired shelf life.

The structure and barrier layers can be combined to comprise several layers of polymers that provide effective barriers and bulk mechanical properties suitable for processing and/or packaging the product, such as clarity, toughness and puncture-resistance.

In some cases, a multilayer sheet of this invention can be formed into a shaped article such as a tray, cup, bottle or the like and additional closure means such as caps, lids or films may be used to complete a container and enclose the contents. In such cases, a sealant layer may be incorporated in the closure means.

In other cases, the multilayer structure of this invention may be a film or sheet that is sealed to itself to form a container or package of this invention. In such cases, the innermost layer of the package is the sealant. Desired sealant can withstand sealing conditions (such as liquid droplets, grease, dust, or the like on the surface of the film). The sealant can have minimum effect on taste or color of the contents and that the sealant be unaffected by the product. The sealant can be a polymeric layer or coating that can be bonded to itself (sealed) at temperatures substantially below the melting temperature of the outermost layer so that the outermost layer's appearance may not be affected by the sealing process and will not stick to the jaws of the sealing bar. Typical sealants used in multilayer packaging films can include ethylene polymers, such as low density polyethylene (LDPE), linear low density polyethylene (LLDPE), and metallocene polyethylene; copolymers of ethylene with vinyl acetate or methyl acrylate (EMA); copolymers of ethylene and acrylic acid or methacrylic acid, optionally as ionomers (i.e., partially neutralized with metal ions such as Na, Zn, or Mg); amorphous nylon; or amorphous PET. Typical sealants can also include PVDC or polypropylene copolymers. Sealant layers are typically from about 2.5 to about 100 μm thick.

Polyolefins suitable for use in the present invention can be polypropylene or polyethylene polymers and copolymers comprising ethylene or propylene. Suitable polyolefins can be prepared by a variety of methods, including well-known Ziegler-Natta catalyst polymerization (e.g., U.S. Pat. Nos. 4,076,698 and 3,645,992), metallocene catalyst polymerization (e.g., U.S. Pat. Nos. 5,198,401 and 5,405,922) and by free radical polymerization. Polyethylene polymers can include linear high-density polyethylene HDPE, LLDPE, very low- or ultra-low density polyethylenes and branched polyethylenes such as LDPE. The densities of polyethylenes suitable for use in the present invention range from 0.865 g/cm³ to 0.970 g/cm³. Linear polyethylenes for use herein can incorporate alpha-olefin comonomers such as butene, hexene or octene to decrease their density within the density range so described.

Polypropylene polymers include propylene homopolymers, impact modified polypropylene and copolymers of propylene and alpha-olefins. A particularly useful polypropylene is PROFAX 6323 polypropylene resin from Basell Polyolefins Inc. having an apparent melt viscosity at 100 1/s apparent shear of 550 Pa-s at 190° C. and 380 Pa-s at 230° C. and melt-point endotherm of 167° C.

Ionomeric resins (“ionomers”) are ionic copolymers of an olefin such as ethylene with a metal salt of an unsaturated carboxylic acid, such as acrylic acid, methacrylic acid, or maleic acid, and optionally softening monomers. At least one or more alkali metal, transition metal, or alkaline earth metal cations, such as sodium, potassium or zinc, are used to neutralize some portion of the acidic groups in the copolymer resulting in a thermoplastic resin exhibiting enhanced properties. For example, E/(M)AA means a copolymer of EAA and/or MAA which are at least partially neutralized by one or more alkali metal, transition metal, or alkaline earth metal cations to form an ionomer. Terpolymers can also be made from an olefin such as ethylene, an unsaturated carboxylic acid and other comonomers such as alkyl (meth)acrylates to provide “softer” resins that can be neutralized to form softer ionomers. Ionomers are known conventionally and their method of preparation is described in, for example, U.S. Pat. No. 3,344,014.

Anhydride or acid-modified ethylene and propylene homo- and copolymers can be used as extrudable adhesive layers (also known as “tie” layers) to improve bonding of layers of polymers together when the polymers do not adhere well to each other, thus improving the layer-to-layer adhesion in a multilayer structure. The compositions of the tie layers may be determined according to the compositions of the adjoining layers that need to be bonded in a multilayer structure. One skilled in the polymer art can select the appropriate tie layer based on the other materials used in the structure. Various tie layer compositions are commercially available under the tradename Bynel® from E.I. du Pont de Nemours and Company, for example. A particularly useful tie layer is Bynel® 21 E810.

Appropriate amounts of various additives can be present in the respective polymer compositions, and structure layers thereof, including tie layers and the like, provided their presence does not substantially alter the properties of the structure. Additives can include plasticizers, stabilizers such as hydrolytic stabilizers, radiation stabilizers, thermal stabilizers, and ultraviolet (UV) light stabilizers, antioxidants, ultraviolet ray absorbers, anti-static agents, colorants, dyes or pigments, delustrants such as TiO₂, fillers, fire-retardants, lubricants, reinforcing agents such as glass fiber and flakes, processing aids such as antiblock agents, release agents, anti-slip agents, slip agents such as talc, anti-block agents, other processing aids, elastomers and the like, and/or mixtures thereof.

As indicated above, it is common to recycle scrap (regrind) from processing operations into articles of manufacture. In some cases, regrind is used as a discrete layer in a multilayer structure, often for bulking purposes. Of note are regrind compositions comprising blends of at least two polyamides. Also of note are regrind compositions comprising blends of at least one partially aromatic polyamide and at least one aliphatic polyamide. Also of note are regrind compositions comprising blends of at least two partially aromatic polyamides. Further of note are blends of polyamide 6I,6T and polyamide 6,6; blends of polyamide 6I,6T and polyamide 6; and blends of polyamide 6I,6T and polyamide MXD6. Accordingly, multilayer structures disclosed herein include structures with (polyester+regrind) layers.

For example, multilayer structures include (1) the multilayer structure comprising a layer comprising polyester, a sulfobenzenedicarboxylic acid-derived polyester copolymer and at least two polyamides; (2) the multilayer structure comprising a layer comprising polyester, a sulfobenzenedicarboxylic acid-derived polyester copolymer and at least one partially aromatic and at least one aliphatic polyamide; (3) the multilayer structure comprising a layer comprising polyester, a sulfobenzenedicarboxylic acid-derived polyester copolymer and at least two partially aromatic polyamides; (4) the multilayer structure comprising a layer comprising polyester, a sulfobenzenedicarboxylic acid-derived polyester copolymer and polyamide 6I,6T and polyamide 6,6; (5) the multilayer structure comprising a layer comprising polyester, a sulfobenzenedicarboxylic acid-derived polyester copolymer and polyamide 6I,6T and polyamide 6; and (6) the multilayer structure comprising a layer comprising polyester, a sulfobenzenedicarboxylic acid-derived polyester copolymer and polyamide 6I,6T and polyamide MXD6.

Articles incorporating regrind can have unacceptable haze due to poor compatibility between the polymeric materials that are mixed together in the regrind. In contrast, articles disclosed herein exhibit reduced haze with the presence of regrind. Accordingly, this invention provides for a multilayer structure and an article thereof that has less than 10% haze, or an article that includes more than 5 weight % regrind that has less than 10% haze.

Article Manufacture

The compositions described herein can be melt-processed into various shaped articles by known processes for conventional polymers and are particularly suited for preparing, among others, thermoformable sheets and films. Thus, multilayer films, sheets, and the like can be produced by co-extrusion, sheet extrusion, extrusion casting, extrusion coating, thermal lamination, blown film methods, powder coating and sintering, or like processes. The films and sheets can be further processed into articles (for example, multilayer containers such as blister packs, trays and cups) with uniaxial or biaxial stretching, axial heat sealing, thermoforming, vacuum forming, sheet folding and heat sealing (form-fill-seal) compression molding or like molding or forming (e.g. extrusion blow molding) processes.

The actual making of the multilayer structure as a film or sheet can generally be by any such method for preparing films or sheets as practiced in the art. As such, the film or sheet structures can be typically coextruded, cast, laminated, and the like, including orientation (either uniaxially or biaxially) by various methodologies (e.g., cast film, cast film followed by orientation, or blown bubble techniques).

A multilayer film structure useful in the present invention can be prepared by coextrusion as follows. Dried granulates of the various components are melted in single screw extruders. The melt temperature can be adjusted up or down to achieve a stable or laminar flow of the polymer melts in the die. The molten polymers can be passed through a flat or circular die to form layered molten polymer film, sheet or tubing. The molten polymers exit the die and may be immediately stretched in the machine and/or transverse direction as melts to achieve goal thicknesses. The melt is then cooled by contact with cool air or water or a quench drum or roll. Polymers can be converted into a film or sheet using other suitable converting techniques. For example, a film useful in the present invention can also be made by coextrusion of a film followed by lamination onto one or more other layers.

Articles may also be cast in a “melt to mold” process, such as extrusion blow molding, wherein the molten extrudate is forced into molds by air pressure and quenched. Another “melt to mold” process involves using quench rolls with shaped cavities that can form such articles as trays directly from the molten extrudate.

The thermoplastic film may also be laminated or extrusion coated to a substrate such as foil, paper, paperboard or nonwoven fibrous material to provide a packaging material useful in this invention. For example, a multilayer structure of this invention can be extrusion coated onto paperboard as follows: dried granulates are melted in single screw extruders. The molten polymers can be passed through a flat die to form molten polymer curtain wherein the individual compositions are present in a laminar flow. The molten curtain drops into the moving porous substrate to be immediately pressed into that substrate and quenched by a quench drum.

The coated paperboard may be formed into a shaped article by folding to provide a rigid container such as a box or carton. A carton prepared from paperboard extrusion coated with a multilayer structure of this invention (wherein the multilayer structure also comprises a sealant layer) can be sealed by flame sealing. Cartons constructed in this manner can be used to contain, for example, orange juice or other fruit juices, and milk or milk products. An example of such a multilayer structure comprises PE (sealant layer)/maleic anhydride-grafted polyolefin (tie layer)/polyamide 6,6/PET+SIPA copolymer blend/PET/paperboard/LDPE.

Paperboard may also be co-extrusion coated for high temperature resistance in the manufacture of corrugated boxes. Corrugated boxes are large containers that are typically used for bulk shipments of products as diversified as fruit and plastic resin pellets. A heat resistant surface (e.g. nylon 6,6) is required for the process of assembling a corrugated paper structure. Tie layers can also be heat resistant and the SIPA copolymers or PET+SIPA copolymer blends are suitable as cost effective heat resistant bulk layers or tie layers. Examples of such multilayer structures include (1) polyamide 6,6/SIPA copolymer/paperboard; (2) polyamide 6,6/PET+SIPA copolymer blend/paperboard; (3) polyamide 6,6/PET+SIPA copolymer blend/PET/paperboard; (4) polyamide 6,6/PET+SIPA copolymer blend/polyamide 6,6/paperboard; and (5) polyamide 6,6/PET+SIPA copolymer blend/PET/PET+SIPA copolymer blend/polyamide 6,6/paperboard.

An example of polyamide 6,6 suitable for use in these multilayer structures is Zytel® 3071, available from DuPont. These structures are subsequently incorporated into corrugated cardboard by laminating a corrugated paperboard between two layers of paperboard, at least one of which is a multilayer structure as described above, such that the polymeric coating is oriented to be on an outer face of the corrugated cardboard. The lamination can be conducted using heated platens and a heat-activated adhesive (e.g. a hot-melt glue) or aqueous-based adhesives that must be dried. Thus, the corrugation process is carried out so that the polymer coating can be on either of the inside, outside, or both inside and outside of the package.

This invention also provides an article comprising corrugated cardboard prepared from a multilayer structure comprising paperboard and a polyester composition comprising from 0.01 to 7 mole % of a sulfobenzenedicarboxylic acid comonomer or a salt thereof.

The packaging material may also be processed further by, for example but not limitation, printing, embossing, and/or coloring to provide a packaging material to provide information to the consumer about the product therein and/or provide a pleasing appearance of the package.

In addition to having good thermoforming capabilities, multilayer structures disclosed herein can have good barrier properties to oxygen, moisture, carbon dioxide, organic liquids such as automotive fuels such as gasoline and diesel fuel, and flavors.

As such, the multilayer structures of this invention can be used in applications for packaging beverages such as carbonated beverages, orange juice, apple juice, grape juice, other fruit juices and milk; solid or semi-solid foods such as meats, cheese, fish, poultry, nuts, coffee, applesauce or other sauces, stews, dried fruit, food paste, soups and soup concentrates and other edible items; spices; condiments such as ketchup, mustard, and mayonnaise; pet food; cosmetics; personal care products such as toothpaste, shaving foam, soaps, shampoos, lotions and the like; pharmaceuticals; fragrances; electronic components; industrial chemicals or household chemicals such as fragrant laundry detergent, fragrant fabric softener; agrochemicals; medical devices; medicinal liquids; fuels; textiles; and biological substances.

The containers and packaging materials can be of various shapes including trays, cups, caps, or lids prepared from sheets by vacuum or pressure forming; shapes prepared by deep drawing an unstretched sheet (i.e. thermoforming); shapes prepared by compression molding or other molding processes, including extrusion blow molding; and shapes prepared by folding a sheet and heat sealing its edges, such as a gable-topped carton.

Shaped articles used in packaging applications including, but not limited to, the containers or portions of containers, films and sheets (1) Containers comprising these multilayer structures; (2) containers of (1) wherein these multilayer structures are in the form of films or sheets; (3) films less than 10 mil thick; (4) a multilayer film or sheet bonded to a substrate selected from the group consisting of paper, paperboard, aluminum foil, fabric, nonwoven material, or to a film substrate comprising another polymer selected from the group consisting of poly(vinylidene fluoride), biaxially oriented polypropylene and polyamide by lamination, extrusion coating or co-extrusion coating; (5) films of (3) that have at least one layer that has been oriented and partially heat set such that the total structure shrinks at least 5% when heated above 90° C.; (6) films of (3) that can be stretched at least 5% without rupture of the film; (7) containers of (1) in the form of thermoformed pouches or bags; (8) multilayer sheets more than 10 mils thick; (9) multilayer sheets or containers greater than 10 mils thick that retain excellent clarity even when more than 5% regrind is used in the structure; (10) containers having at least one opening (formed for example by thermoforming) from sheets of (8) or (9) or lined with (3) or (4)) including but not limited to pouches, trays, tubs, cups, bowls, boxes, cartons, cans, buckets, pails, and bottles; (11) containers of (1) that are rigid containers comprising these multilayer structures, including but not limited to trays, cups, cans, buckets, tubs, boxes, bowls, and cartons; (12) a component of a container (such as a cap, cap liner, lid, screw top, or other closure) comprising these multilayer structures; (13) containers of (1) that are retortable, steam sterilizable and/or microwaveable such as but not limited to cups, bowls, pouches, and tubes; (14) containers of (1) containing fuel components such as gasoline, methane, methanol, and oxygen; (15) containers of (1) that also comprise a scavenging layer for scavenging oxygen, moisture, or odors; (16) containers of (1) that comprise another barrier layer such as a metal foil layer; metal, silica, alumina, or carbon coated film layer; polyvinylidene chloride; or polyglycolic acid; (17) containers of (1) that are under vacuum or contain a vacuum; (18) containers of (1) that contain a gas or gases; (19) containers of (1) or container components (11) or sheets (3), (4), (8) or (9) that additionally comprise a pigment; (20) films or sheets of (3), (4), (8) or (9) that have superior clarity even when regrind is included; (21) bags or pouches of within a rigid container that dispense liquids such as wine, medical fluids, or baby formula; (22) containers of (1) that are blister packs; (23) boxes or cartons containing orange juice, fruit juice, milk, soup, baby food, soup concentrate, soup, pet food, or other edible products; (24) containers of (1) containing foods such as pet food, applesauce, stews, soups, dried fruit, food paste, meats, or other edibles; or containing medical products; (25) containers of (1) containing detergents, fragrances or agrochemicals; (26) containers of (1) containing baby foods, relishes, condiments such as ketchup, mayonnaise, or mustard, vinegar, flavorings, or herbs; (27) containers of (1) containing pharmaceuticals or medical equipment; (28) containers of (1) that contain pressurized products such as but not limited to beer, soda, carbonated water, shaving cream, expandable foams, and insecticides; and (29) containers that are retorted.

The following Examples are presented to more fully demonstrate and further illustrate various aspects and features of the present invention and not meant to be unduly limiting.

### EXAMPLES

Unless stated otherwise, all percentages, parts, etc. are by weight.

Polyester compositions comprising a sulfobenzenedicarboxylic acid (SIPA) comonomer (typically, a salt thereof were prepared according to standard methods. SIPA copolymer refers to a copolymer of SIPA and polyester wherein the neutralizing salt is not specified. When a cation is denoted (e.g. Na) the copolymer comprises that cation. “PET+SIPA copolymer blend” refers to PET blended with a SIPA copolymer. “PA” refers to polyamide. “Regrind” refers to a composition comprising polyester, SIPA copolymer, polyamide and/or polycarbonate (and/or any other polymers present in the multilayer structure), as described above.

### Example 1

This example was a copolyester of terephthalic acid (or dimethyl terephthalate), ethylene glycol and 5-sodium sulfodimethylisophthalate (1.72 mole % based on the acid component) having an IV of 0.56.

### Example 2

This example was a copolyester of terephthalic acid (or dimethyl terephthalate), ethylene glycol and 5-sodium sulfodimethylisophthalate (2.0 mole % based on the acid component) with 0.3 weight % TiO₂. The IV of the copolymer was 0.50.

### Examples 3-10

Coextruded sheets were prepared by coextrusion as follows. Dry granulates of components were melted in extruders. The molten polymers were passed through a die or set of dies to form layers of molten polymers that were processed as a laminar flow. The molten polymers were cooled to form a layered sheet structure. Example coextruded sheets are listed in Table 1 in which all sheets except Example 9 were made.

TABLE 1

| Example | Sheet Structure |
|---|---|
| 3 | PA 6I,6T/SIPA PET copolymer |
| 4 | PA 6I,6T/(PET + SIPA copolymer) |
| 5 | (PET + SIPA copolymer)/(blend of 70% PA 6I,6T + |
| | 30% PA 6,6)/(PET + SIPA copolymer + regrind) |
| 6 | PET/(SIPA copolymer)/PA blend/(SIPA copolymer)/ |
| | regrind layer |
| 7 | PET/(SIPA copolymer)/PA MXD6/(SIPA copolymer)/ |
| | regrind layer |
| 8 | PET/(SIPA copolymer)/(PA MXD6 + PA 6I,6T blend)/ |
| | (SIPA copolymer)/regrind layer |
| 9 | (Nucleated, toughened PET)/Toughened SIPA |
| | copolymer/polyamide/Toughened SIPA copolymer/ |
| | (Nucleated, toughened PET)^{A} |

### Example 11

A multilayer cast sheet was prepared using standard cast film procedures. The five-layer structure was Crystar® 5005 polyester/0.7% Na SIPA PET copolymer/(PA6+PA 6I,6T blend)/1.7% Na SIPA PET copolymer/Crystar® 5005 polyester. This cast sheet had excellent clarity and the layers could not be separated at ambient relative humidity and temperature.

### Examples 12-16

Multilayer sheets are described in Table 2.

TABLE 2

| Example | Sheet Structure |
|---|---|
| 12 | (0.95 IV PET + toughener)/(SIPA copolymer + |
| | toughener)/Toughened PA MXD6/(SIPA copolymer + |
| | toughener)/(0.95 IV PET + toughener) |
| 13 | (0.95 IV PET)/(SIPA copolymer)/PA MXD6/SIPA |
| | copolymer/(0.95 IV PET) |
| 14 | (Nucleated 0.95 IV PET + toughener)/(SIPA |
| | copolymer + toughener)/Toughened MXD6/(SIPA |
| | copolymer + toughener)/(nucleated 0.95 |
| | IV PET + toughener) |
| 15 | (0.95 IV PET + toughener)/(SIPA copolymer + |
| | toughener)/Toughened PA 6I,6T/(SIPA copolymer + |
| | toughener)/(.95 IV PET + toughener) |
| 16 | (Nucleated 0.95 IV PET + toughener)/(SIPA |
| | copolymer + toughener)/Toughened PA 6I,6T/(SIPA |
| | copolymer + toughener)/(Nucleated 0.95 IV |
| | PET + toughener) |

### Example 17

A 20-inch wide, 3 mil thick multilayer cast film was coextruded at 80 feet/minute. The three-layer structure was 1.5 mil Nylon 6/0.5 mil 1.7% Na SIPA copolymer/1 mil ethylene/methyl acrylate (24 weight %) copolymer (EMA). The film was tested for interlayer adhesion. The Nylon 6/Na SIPA copolymer interface could not be separated. The EMA/SIPA copolymer interface had strong but peelable (i.e. the layers separate cleanly) bonds.

### Example 18

A 20-inch wide multilayer cast film was coextruded. The four-layer structure was 1.5 mil PET polyester/0.5 mil 1.7% Na SIPA copolymer/1 mil PA6I,6T blend/0.5 mil ethylene/methacrylate acid copolymer partially neutralized with sodium (an ionomer).

### Examples 19-23

Table 3 shows multilayer films made (Examples 19-21) using standard coextrusion procedures. Examples 22-23 were not made.

TABLE 3

| Example | Film Structure |
|---|---|
| 19 | PA 6I,6T/Na SIPA PET copolymer |
| 20 | PET/SIPA copolymer/PA MXD6/SIPA copolymer/ |
| | regrind/PET |
| 21 | (PA 6I,6T + PA 6 blend)/Na SIPA PET copolymer/ |
| | regrind |
| 22 | PET/SIPA copolymer/PA 6I,6T/maleic anhydride |
| | polypropylene graft copolymer/polypropylene |
| 23 | PET/SIPA copolymer/PA 6/EVOH/maleic anhydride LDPE |
| | graft copolymer/LDPE |

### Examples 24-29

20 mil-thick cast sheets consisting of mixtures of PET (available from DAK America as Laser+®), 0% or 5% of a polyamide or polyamide blend, and 0% or 5% Na SIPA PET copolymer were prepared to simulate regrind layers in order to examine the effect of a regrind composition on sheet appearance. Comparative Example C1 was a sheet consisting of 100% PET. Comparative Example C2 was a sheet consisting of polyester and a polyamide blend that did not contain a SIPA copolymer. Haze and color were visually assessed and rated qualitatively. The sheets are summarized in Table 4.

TABLE 4

| | | NaSIPA | | | |
|---|---|---|---|---|---|
| | PET | PET | Polyamide | | |
| Example | (wt %) | (wt %) | (wt %) | Haze | Color |
| C1 | 100 | 0 | 0 | Crystal clear | Colorless |
| 24 | 95 | 5 | 5% PA6 | Very hazy | Milky white |
| C2 | 95 | 0 | 5% (50/50 PA6 + PA 6I,6T) | hazy | Light green |
| 25 | 90 | 5 | 5% (50/50 PA6 + PA 6I,6T) | Clear (some haze) | Bluish green |
| 26 | 90 | 5 | 5% (30/70 PA6 + PA 6I,6T) | clear | Very light |
| | | | | | yellow |
| 27 | 90 | 5 | 5% PA 6I,6T | Clear | yellowish |
| 28 | 90 | 5 | 5%(60% NaSIPA pet + 40% | Very clear | Colorless |
| | | | MXD6) | | |
| 29 | 90 | 5 | 5% (30/70 PA6,6 + PA 6I,6T) | Clear(Very lighthaze) | Colorless |

Table 4 shows that incorporation of a SIPA copolymer in the composition improved clarity over a composition without a SIPA copolymer (Compare Example 25 to Comparative Example C2). When the ratio of polyamide 6 to polyamide 6I,6T was below 50/50 (e.g. 30/70), clear sheets were obtained with incorporation of a SIPA copolymer. The composition of the nylon blend can be adjusted in order to achieve clarity in the regrind. The presence of SIPA copolymers helped to reduce the particle size of the nylon phase and reduce haze. Also, Example 26 had better clarity and color than Example 25 or 27.

### Example 30

The multilayer sheet from Example 11 was cut into squares. A square sheet was applied in a horizontal position to a laboratory thermoformer for testing thermoformability in a batch-mode. Heat was applied from a black-body radiator from above and below the sheet until the surface temperature of the sheet rose toward the nominal forming temperature of 195° F. The mold was a heated aluminum mold to provide a shaped article that simulated a pet-food can 8.25 cm in diameter and 3.8 cm deep. At the end of the heat-cycle the sheet was immediately positioned over the mold and clamped to the mold perimeter. Vacuum from within the mold during two seconds drew the sheet into the mold. The molded sheet was ejected after cooling. The sheet had completely reproduced the inside shape of the mold.

### Example 31

The multilayer sheet from Example 11 was again cut into squares and each square was thermoformed into a deep cup, 8.25 cm in diameter and 5.6 cm deep, using black-body radiative heating and a 195° F. sheet temperature. The inner shape of the mold was completely replicated.

### Examples 32-34

The multilayer sheet from cast sheet Example 14 is cut into squares. A square sheet is applied in a horizontal position to a laboratory thermoformer for testing thermoformability in a batch-mode. Heat is applied from a black-body radiator from above and below the sheet until the surface temperature of the sheet rises toward the nominal forming temperature of 260° F. The aluminum mold is heated to 350° F. to provide a crystallized, shaped article that simulates a pet-food can 8.25 cm in diameter and 3.8 cm deep. At the end of the heat-cycle the sheet is immediately positioned over the mold and clamped to the mold perimeter. Vacuum from within the mold during two seconds draws the sheet into the mold. The molded sheet is ejected after crystallization. The sheet expects to reproduce the inside shape of the mold. Crystallinity is expected between 10% and 45% in the finished PET layer.

The multilayer sheet from Example 14 is cast directly onto a plurality of molds. The molten multilayer sheet is drawn into the molds with vacuum. The molded sheet is ejected after crystallization. The sheet expects to reproduce the inside shape of the mold. Crystallinity is expected between 10% and 45% in the finished PET layer.

A multilayer structure from Example 13 is extruded from an annular die to create a parison. The parison is captured in a mold in a conventional extrusion blow molding operation. The parison is cut and a blow pin is inserted to form a neck in the bottle. The parison is then inflated so that it completely fills the mold. The molded bottle is ejected and trimmed. The sheet expects to reproduce the inside shape of the mold with excellent clarity.

1. A multilayer structure comprising a first layer, a second layer, and, optionally, a third layer, a fourth layer, a fifth layer, a polyolefin layer, a barrier layer, or combinations of two or more thereof wherein
the first layer comprises or is produced from a sulfobenzene-dicarboxylic acid-containing polyester, a sulfobenzenedicarboxylic acid-containing polycarbonate, or both wherein
the second layer comprises or is produced from polyamide, a blend of at least two polyamides, a blend of at least one partially aromatic and at least one aliphatic polyamide, a blend of at least two partially aromatic polyamides, a blend of polyamide 6I,6T and polyamide 6,6, a blend of polyamide 6I,6T and polyamide MXD6, a blend of polyamide 6I,6T and polyamide 6, a blend of polyamide 6I,6T, polyamide 6, and polyamide MXD6, or combinations of two or more thereof;
the sulfobenzenedicarboxylic acid-containing polyester comprises from 0.01 to 7 mole % of a sulfobenzenedicarboxylic acid comonomer or a salt thereof, a random copolyester, a block copolyester, or a blend of bulk polyester and a copolymer of polyester and a sulfobenzenedicarboxylic acid comonomer or a salt thereof;
the sulfobenzenedicarboxylic acid comonomer is a salt of alkali metal ion, alkaline earth metal ion, transition metal ion, or combinations of two or more thereof;
the third layer comprises or is produced from polyester;
the fourth layer comprises or is produced from polycarbonate;
the fifth layer comprises or is produced from foil, paper, paperboard and nonwoven fibrous material; and
the barrier layer comprises or is produced from ethylene/vinyl alcohol copolymer, polyalcohol ether, polyvinylidene chloride, polyamide, polyacrylonitrile, polyester, polyester, resorcinol diacetic acid-based copolyester, polyalcohol amine, isophthalate-containing polyester, polyethylene naphthalate or its copolymer, or combinations of two or more thereof.

2. The multilayer structure of claim 1 further comprising the second layer, the third layer, the fourth layer, the fifth layer, the polyolefin layer, the barrier layer, or combinations of two or more thereof wherein the barrier layer comprises or is produced from ethylene/vinyl alcohol copolymer.

3. The multilayer structure of claim 2 wherein the multilayer structure comprises the layers including
polyamide 6,6; SIPA copolymer; and paperboard;
polyamide 6,6; PET and SIPA copolymer blend; and paperboard;
polyamide 6,6; PET and SIPA copolymer blend; PET; and paperboard;
polyamide 6,6; PET and SIPA copolymer blend; polyamide 6,6; and paperboard;
polyamide 6,6; PET and SIPA copolymer blend; PET; PET and SIPA copolymer blend; polyamide 6,6; and paperboard; or
polyethylene; maleic anhydride-grafted polyolefin; polyamide 6,6;
PET and SIPA copolymer blend; PET; paperboard; and LDPE.

4. The multilayer structure of claim 2 comprising regrind and being substantially transparent or low haze.

5. The multilayer structure of claim 2 wherein the ion is calcium, zinc, lithium, sodium, or combinations of two or more thereof.

6. The multilayer structure of claim 5 wherein the fifth layer comprises or is produced from paperboard.

7. The multilayer structure of claim 5 wherein the ion is sodium ion.

8. The multilayer structure of claim 2 further comprising an additive including a toughener, a nucleation agent, inorganic filler, or combinations of two or more thereof.

9. The multilayer structure of claim 8 further comprising an adhesive layer.

10. The multilayer structure of claim 5 further comprising an additive including a toughener, a nucleation agent, inorganic filler, or combinations of two or more thereof.

11. The multilayer structure of claim 10 comprising regrind.

12. An article comprising a multilayer structure as recited in claim 1 wherein the article is optionally a container, tray, bottle, or combinations of two or more thereof and optionally for refrigerated or ambient application.

13. The article of claim 12 wherein the multilayer structure is as recited in claim 2.

14. The article of claim 12 wherein the multilayer structure is as recited in claim 4.

15. The article of claim 12 wherein the multilayer structure is as recited in claim 8.

16. The article of claim 12 wherein the multilayer structure is as recited in claim 10.

17. The article of claim 16 wherein the multilayer structure is as recited in claim 12 and is microwaveable, retortable, or dual ovenable.

18. The article of claim 12 produced by thermoforming or by cast in a “melt to mold” process.

19. The article of claim 14 including the characteristics of having less than 10% haze, including more than 5 weight % regrind, for refrigerated or ambient applications.

20. The article of claim 12 wherein the multilayer structure is as recited in claim 3 and the article is for packaging refrigerated or frozen food products, or for corrugated cardboard.
